(19) United States
(12) Patent Application Publication
(10) Pub. No.: US 2026/0243659 A1
(43) Pub. Date: Aug. 20, 2026

(54) 3D PRINTING OF FUNCTIONALIZED QUANTUM SILICON CARBIDE WITH COLOR CENTERS FOR QUANTUM SENSING

(71) Applicant: Toyota Motor Engineering & Manufacturing North America, Inc., Plano, TX (US)

(72) Inventors: Ercan M. Dede, Ann Arbor, MI (US); Paul Donald Schmalenberg, Ann Arbor, MI (US); Taishi Kimura, Chicago, IL (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/054,447

(22) Filed: Feb. 14, 2025

(51) Int. Cl. G01N 21/17; B28B 1/00; B33Y 10/00; G05B 23/02

(52) U.S. Cl. CPC G01N 21/17; B28B 1/001; G05B 23/0283; B33Y 10/00; G01N 2021/1738

(57) ABSTRACT

Systems, apparatuses, and methods provide for predicting a remaining useful life of apparatus utilizing quantum sensors. A layer of functionalized quantum silicon carbide material of a quantum sensor embedded within a device is excited via a light source of the quantum sensor, where the layer of functionalized quantum silicon carbide material has color centers. The excitation of the layer of functionalized quantum silicon carbide material is sensed via a photodetector of the quantum sensor. One or more of a magnetic field, a temperature, or a strain field effect of the device is measured based on the sensed excitation of the layer of functionalized quantum silicon carbide material. A remaining useful life of the device is predicted based on one or more of the measured magnetic field, the measured temperature, or the measured strain field effect.

### TECHNICAL FIELD

Embodiments generally relate to quantum sensing. More particularly, embodiments relate to 3D printing with functionalized quantum silicon carbide with color centers for quantum sensing.

### BACKGROUND

Mechanical or electrical components are often subject to external stimuli, such as heat, mechanical strain, laser/optics, and/or magnetic fields/microwaves. Such external stimuli can negatively impact the remaining useful life (RUL) of such mechanical or electrical components.

### BRIEF DESCRIPTION OF THE DRAWINGS

Various examples will be described below by referencing the following drawings, in which:

FIG. 1 is a diagram illustrating a thermally, mechanically, and/or magnetically induced stress in a quantum material according to an example;

FIG. 2 is a diagram illustrating detection of thermally and/or magnetically induced stress in a quantum material according to an example;

FIG. 3 is a schematic diagram illustrating a binder jet 3D printer according to an example;

FIG. 4 is a perspective view illustrating a rotating device incorporating a quantum sensor according to an example;

FIG. 5 is a side view illustrating a semiconductor package incorporating a quantum sensor according to an example;

FIG. 6 is a side view illustrating an electronic assembly with a cold plate incorporating a quantum sensor according to an example;

FIG. 7 is a side view illustrating an electronic assembly with a heat sink incorporating a quantum sensor according to an example;

FIG. 8 an illustration of a flowchart of an example method for forming a quantum sensor according to an example;

FIG. 9 an illustration of a flowchart of another example method for forming a quantum sensor according to an example;

FIG. 10 is an illustration of a flowchart of an example method for quantum sensor operation according to an example;

FIG. 11 is an illustration of a flowchart of another example method for quantum sensor operation according to an example;

FIG. 12 is an illustration of a flowchart of a further example method for quantum sensor operation according to an example;

FIG. 13 is a block diagram illustrating a computer program product according to an example;

FIG. 14 is a block diagram illustrating an example computing apparatus according to an example;

FIG. 15 is a block diagram illustrating a hardware apparatus including a semiconductor package according to an example.

### DETAILED DESCRIPTION

As will be described in greater detail below, systems, apparatuses, and methods are described for predicting a remaining useful life of devices utilizing quantum sensors. A layer of functionalized quantum silicon carbide material of a quantum sensor embedded within a device is excited via a light source of the quantum sensor, where the layer of functionalized quantum silicon carbide material has color centers. The excitation of the layer of functionalized quantum silicon carbide material is sensed via a photodetector of the quantum sensor. One or more of a magnetic field, a temperature, or a strain field effect of the device is measured based on the sensed excitation of the layer of functionalized quantum silicon carbide material. A remaining useful life of the device is predicted based on one or more of the measured magnetic field, the measured temperature, or the measured strain field effect.

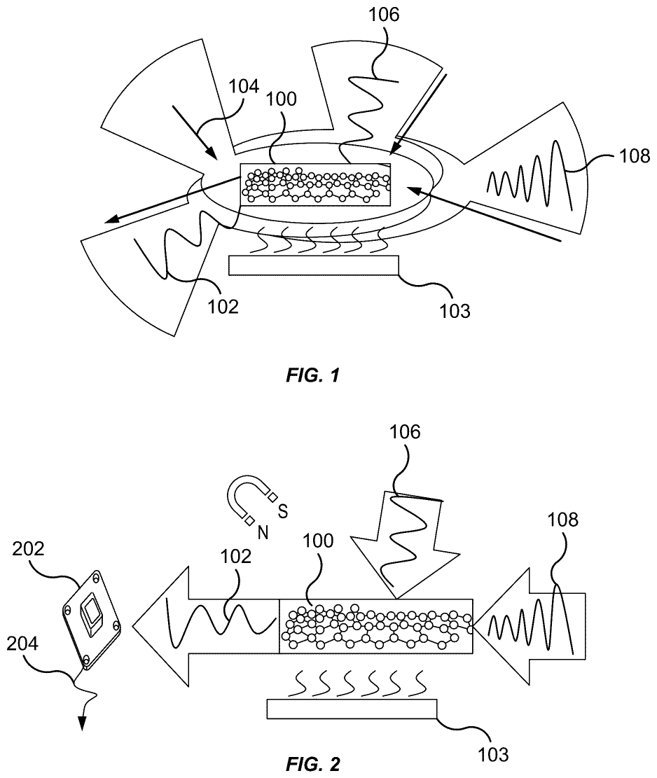

FIG. 1 is a diagram illustrating a thermally, mechanically, and/or magnetically induced stress in a quantum material. As illustrated, quantum materials 100 may be designed to have color centers to provide quantum sensing. Defects within the lattice structure of the quantum material 100, such as diamond, are filled with another element, such as nitrogen, which create the color center. The color centers emit a light signal 102 in response to external stimuli, such as heat 103, mechanical strain 104, laser/optics 106, and/or magnetic fields/microwave 108, as shown.

FIG. 2 is a diagram illustrating detection of thermally and/or magnetically induced stress in the quantum material 100. As illustrated, the light signal 102 that is emitted by the color centers in the quantum material 100 can then be detected by a photodetector 202. Such a photodetector 202 outputs a voltage 204 that is indicative of the external stimuli, such as heat 103, magnetic fields/microwave 108, and/or the like. For example, such an output voltage 204 is utilized to obtain an optically determined magnetic resonance. Optically determined magnetic resonance uses the resonance of the spin defects inside color centers to greatly enhance the sensitivity of the device to weak fields.

As will be described in greater detail below, some implementations herein utilize a functionalized quantum silicon carbide. Such functionalized quantum silicon carbide is composed of silicon carbide designed to have color centers to provide quantum sensing. Such color centers may be formed by creating defects within the lattice structure of the silicon carbide. For example, such defects are filled with another element, such as nitrogen, which create the color center. Additionally, or alternatively, titanium and molybdenum can occupy vacancies in the lattice to form operational color centers.

In other implementations, the color centers can be activated through just a vacancy in the lattice. For example, in silicon carbide (SiC), there can be defects of just silicon (Si) vacancy, a defect where a Si atom is removed, but the carbon (C) atom jumps to the new vacancy and leaves its own vacancy, and a vacancy where both the Si and C atom are missing in the lattice. Such Di-vacancy can be abbreviated as “Vc-Vsi,” where the big V and C are the atoms present, with V meaning vacancy and the smaller subscript indicating what is usually there for that lattice. “Csi” represents the C atom sitting on the Si site. In general, many point defect species exist, such as Vsi, Vc, Vsi-Csi, and Vsi-Vc. Among them, in the case of the SiC, several point defects such as Vsi, Vsi-Vc, Nc-Vsi (Carbon site nitrogen and adjacent Si vacancy) work as color centers.

Some embodiments of the present disclosure use a powder having particles of such functionalized quantum silicon carbide with quantum color centers to 3D print parts having quantum sensing capabilities. Thus, the parts themselves have an embedded inherent quantum sensor.

In some implementations, the process is directed to binder jet 3D printing of functionalized quantum material powder with color centers for quantum sensing. As a non-limiting example, the quantum material powder may be functionalized quantum silicon carbide, with the particles containing one or more defects that act as color centers. Such functionalized quantum silicon carbide may be thermal tolerable to have an annealing temperature between 600 degrees Celsius and 1800 degrees Celsius.

The defects in the functionalized quantum silicon carbide may be fabricated within a bulk substrate that is then ground to create the powder. In other embodiments, the particles having defects are grown. For example, multivalency defects in 4H-SiC silicon carbide may be achieved at specific ranges of annealing temperatures and monitoring electron paramagnetic resonance (EPR) spectrogram. In other implementations, other polymorphs of silicon carbide may be utilized. For example, 6H-SiC silicon carbide may be utilized, e.g., for applications prioritizing light emission, high annealing temperatures and/or mechanical durability.

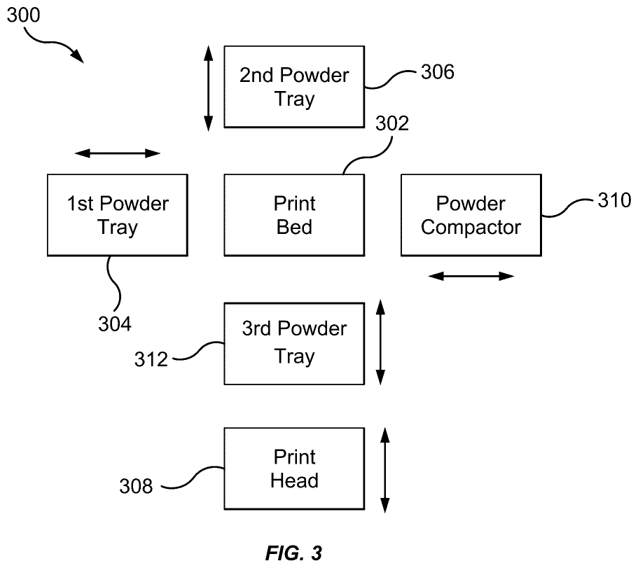

FIG. 3 is a schematic diagram illustrating a binder jet 3D printer 300. As illustrated, the binder jet 3D printer 300 includes a print bed 302, a first powder tray 304, a second powder tray 306, a print head 308, and a powder compactor 310.

In operation, the binder jet 3D printer 300 builds layers of material by depositing raw powder from the first powder tray 304 or the second powder tray 306. In the present application, two powder trays are utilized so that the first powder tray 304 contains unaltered silicon carbide while the second powder tray 306 contains the functionalized quantum silicon carbide. Depending on the location of the layer currently being deposited, a selection is made between depositing a layer of unaltered silicon carbide via the first powder tray 304 or the functionalized quantum silicon carbide via the second powder tray 306.

The raw powder is compacted via the compactor 310. This compacted raw powder is then patterned with a fixative deposited via the print head 308 in a desired patten. The process of powder deposition, compaction and fixative patterning is repeated to form a device. The device is then solidified as a green part via curing to dry and crosslink the fixative. The device as the green part is sintered after curing. By selectively depositing and patterning one or more functionalized quantum silicon carbide layers, an embedded functionalized quantum defect may be formed in the device.

In one case, the functionalized powder is optionally mixed/sprayed with a slurry during the printing process so that the functionalized powder can be sintered below 1000 degrees Celsius. A non-limiting example slurry is liquid sodium water glass (e.g., Sodium Silicate) mixed with zirconia powder. Polyvinyl alcohol (PVA) at a weight percent of ~8% may then be added to the slurry mixture as a binder. In another case, functionalized powder without a slurry is utilized and sintering occurs at a higher temperature such as 1400 degrees Celsius. In either case, a polymer or phenolic binder (e.g., PVA, or other binders) may also be sprayed on to the powder, or mixed into the slurry as described above, prior to or during the printing process. This slurry/polymer or phenolic binder mixture may then be burned off at a lower temperature than the sintering temperature prior to sintering or during sintering process itself. The functionalized powder and optional slurry/binder mix is then 3D printed using the process above to form a fully dense part with functionalized defects for quantum sensing.

In some implementations, the zirconia powder may be excluded from the slurry. In such implementations, the zirconia powder may instead be mixed with the silicon carbide powder in the first powder tray 304 and/or mixed with the functionalized quantum silicon carbide powder in the second powder tray 306. Alternatively, a third powder tray 312 may be utilized to contain and separately apply zirconia powder. As with trays 304 and 306, the raw powder from the third powder tray 312 is compacted via the compactor 310. This compacted raw powder is then patterned with a fixative deposited via the print head 308 in a desired patten.

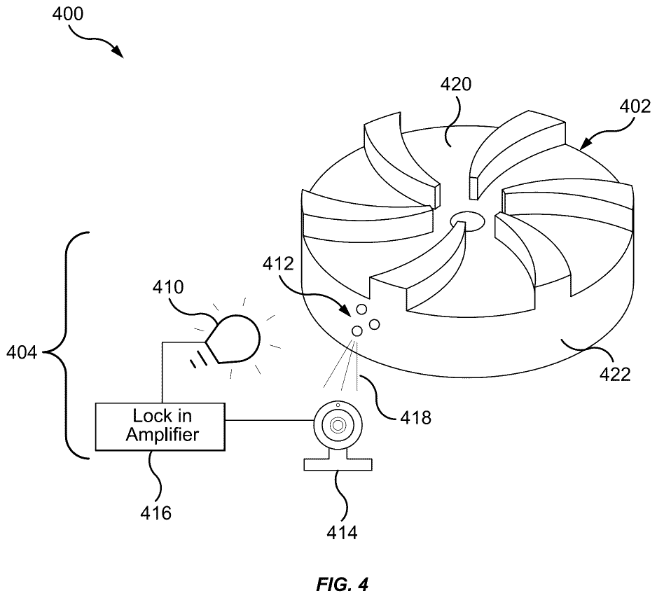

FIG. 4 is a perspective view illustrating an apparatus 400 including a rotating device 402 incorporating a quantum sensor 404. As illustrated, the quantum sensor 404 may be placed near the edge of the rotating device 402 during operation.

The quantum sensor 404 includes a light source 410, embedded functionalized defects 412 (e.g., embedded within the rotating device 402), a photodetector 414, and/or a lock in amplifier 416.

As illustrated, the apparatus 400 includes a substrate 420 comprising a plurality of 3D printed layers of silicon carbide. The quantum sensor 404 may be located on a side 422 of the substrate 420 (e.g., the plurality of 3D printed layers of functionalized quantum silicon carbide are located at least partially on an outer diameter of the rotatable device 402). The quantum sensor 404 comprises a plurality of 3D printed layers of functionalized quantum silicon carbide with color centers, e.g., as is illustrated by embedded functionalized defects 412. As described above, the quantum sensor 404 is configured to measure one or more of a magnetic field, a temperature, or a strain field effect.

The photodetector 414 can detect the light 418 produced by the embedded functionalized defects 412 in response to light emitted from the light source 410 as a result of temperature and/or strain on the rotating device 402. The photodetector 414 may also sense the embedded functionalized defects 412 response to a change in electromagnetic field. The light 418 produced by the rotating device 402 can be monitored for changes over time. Changes may be indicative of impending part failure, for example, or a change in an externally applied stress or electromagnetic field. Thus, preventative maintenance (e.g., replacement) or a change in rotational operating speed/conditions may be carried out (e.g., to reduce stress) before the part fails for components that are not easily replaced.

As an additional feature, the light source 410 and the photodetector 414 may be modulated and synchronized at several thousand hertz. Then using the lock in amplifier 416, a sensor output map may be built based off of the rotational speed of the rotating device 402. For example, a modulating light source 410 is synchronized to the rotations speed of the device 402, with the lock in amplifier receiving the output of the photodetector 414 at the same modulation rate which allows the quantum sensor 404 to probe the same location of the device on every rotation. For example, this might be utilized to build real-time strain maps of parts somewhat akin to laser vibrometry for turbine blade tip displacement and mode shape analysis by slightly offsetting the modulation rate of the quantum sensor from the rotational speed such that the probed point transits across the device. However, unlike laser vibrometry, this technique would readout quantum spin information for real-time information on part state of health.

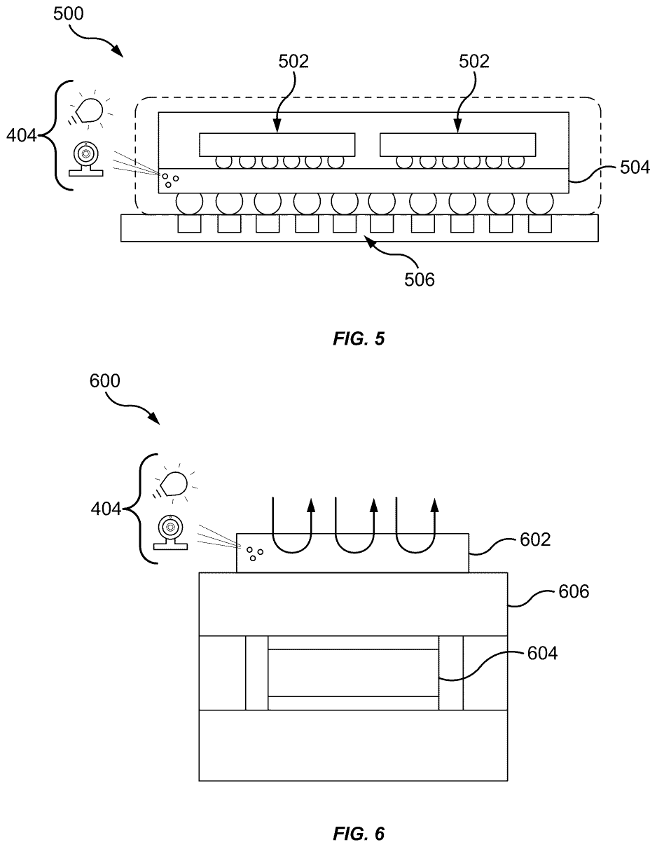

FIG. 5 is a side view illustrating a semiconductor package 500 incorporating the quantum sensor 404. As illustrated, the semiconductor package 500 includes one or more integrated circuits 502 coupled to a ceramic substrate 504, which in turn is coupled to a printed circuit board 506. The integrated circuits 502 may be formed in a rectangular piece of semiconductor material called a chip or a die. Examples of the semiconductor material include, but are not limited to silicon, silicon on sapphire, gallium arsenide, the like, and/or combinations thereof. In some embodiments, the integrated circuits 502 may be processors. For example, the integrated circuits 502 may be microprocessors.

One or more quantum sensors 404 may be incorporated into the ceramic substrate 504. The one or more quantum sensors 404 may be used for temperature sensing, hot-spot detection, and/or thermal-stress sensing, for example.

FIG. 6 is a side view illustrating an electronic assembly 600 with a cold plate 602 incorporating a quantum sensor. As illustrated, the electronic assembly 600 includes one or more integrated circuits 604 coupled to the cold plate 602 via a heat spreader 606 (or optionally coupled directly to the cold plate 602 without the heat spreader 606). Additionally, or alternatively, thermal interface material (TIM) may be inserted between the cold plate 602 and the heat spreader 606 and/or between the integrated circuits 604 and the heat spreader 606 in order to enhance the thermal coupling between them.

As used herein the term “cold plate” refers to a thermal management component that cools high-heat devices by transferring heat directly to a liquid coolant flowing through the plate. One or more quantum sensors 404 may be incorporated into the cold plate 602. The one or more quantum sensors 404 may be used for temperature sensing, hot-spot detection, and/or thermal-stress sensing, for example.

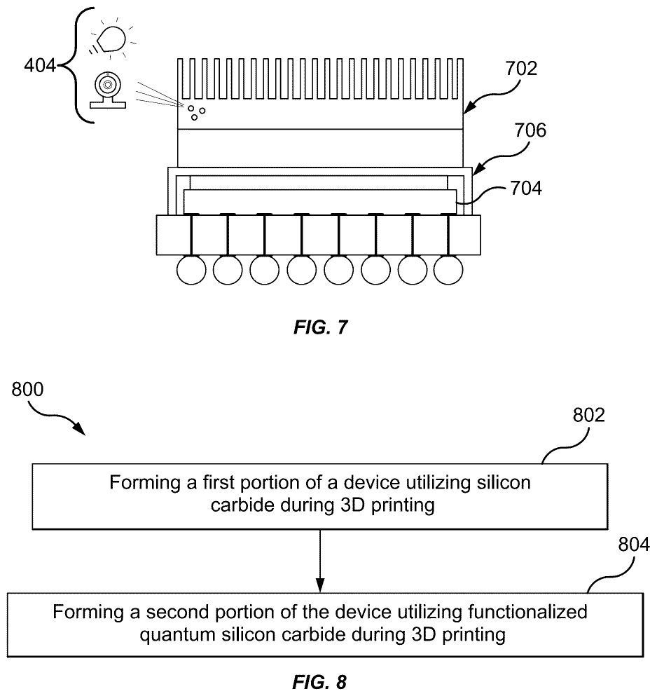

FIG. 7 is a side view illustrating an electronic assembly 700 with a heat sink 702 incorporating a quantum sensor 404. As illustrated, the electronic assembly 700 includes one or more integrated circuits 704 coupled to the heat sink 702 via a heat spreader 706 (or optionally coupled directly to the heat sink 702 without the heat spreader 706). Additionally, or alternatively, thermal interface material (TIM) may be inserted between the heat sink 702 and the heat spreader 706 and/or between the integrated circuits 704 and the heat spreader 706 in order to enhance the thermal coupling between them.

As used herein the term “heat sink” refers to a thermal management component that cools high-heat devices by transferring heat via a passive heat exchanger to a fluid medium, often air or a liquid coolant, where it is dissipated away from the device. As illustrated, The heat sink 702 may include a base and fins extending from the base. Further, the heat sink 702 may be any known or to-be-designed heat dissipation mechanism. One or more quantum sensors 404 may be incorporated into the heat sink 702. The one or more quantum sensors 404 may be used for temperature sensing, hot-spot detection, and/or thermal-stress sensing, for example.

The rotating device 402 of FIG. 4, the semiconductor package 500 of FIG. 5, electronic assembly 600 of FIG. 6, electronic assembly 700 of FIG. 7 may be incorporated into a vehicle. For example, such a vehicle may be an automobile. In other examples, such a vehicle may be a motorcycle, an electronic bicycle, an aircraft, the like, and/or combinations thereof.

FIG. 8 an illustration of a flowchart of an example method 800 for forming a quantum sensor according to an example. The method 800 may generally be implemented to form an apparatus, such as, for example, the rotating device 402 of FIG. 4, the semiconductor package 500 of FIG. 5, the electronic assembly 600 of FIG. 6, and/or the electronic assembly 700 of FIG. 7, already discussed.

Illustrated processing block 802 provides for forming a first portion of a device utilizing silicon carbide during 3D printing.

As will be described in greater detail below, forming a first portion of a device utilizing silicon carbide during 3D printing includes: feeding silicon carbide powder onto a print bed of a 3D printer; compacting the silicon carbide powder; and spraying a fixative onto the silicon carbide powder to form one or more fixed silicon carbide layers.

Illustrated processing block 804 provides for forming a second portion of the device utilizing functionalized quantum silicon carbide during 3D printing, where the layer of functionalized quantum silicon carbide material has color centers.

As will be described in greater detail below, forming a second portion of the device utilizing functionalized quantum silicon carbide during 3D printing includes: feeding functionalized quantum silicon carbide powder onto the print bed of the 3D printer; compacting the functionalized quantum silicon carbide powder; and spraying the fixative onto the functionalized quantum silicon carbide powder to form one or more functionalized quantum fixed silicon carbide layer where the one or more functionalized quantum fixed silicon carbide layers form an embedded functionalized quantum defect in the device.

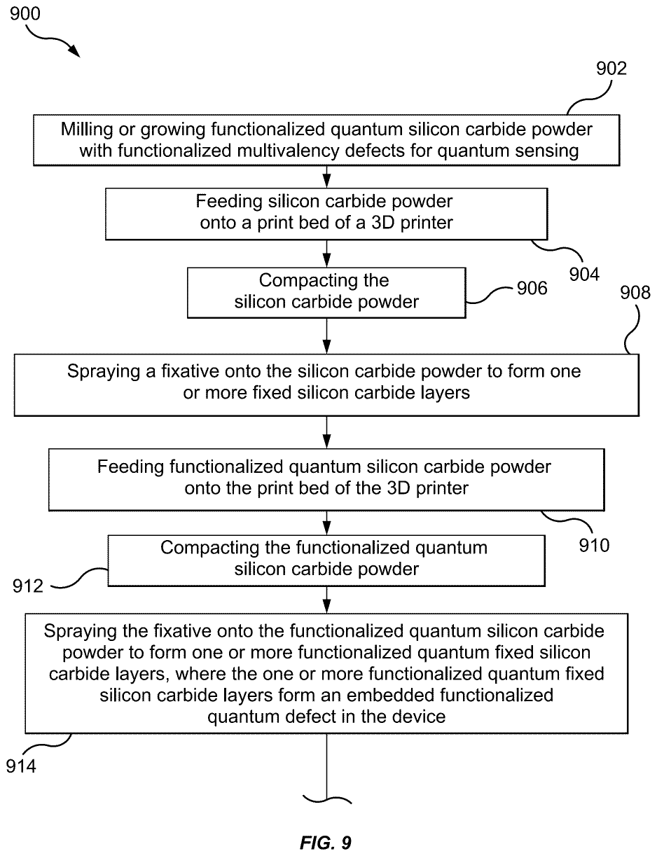

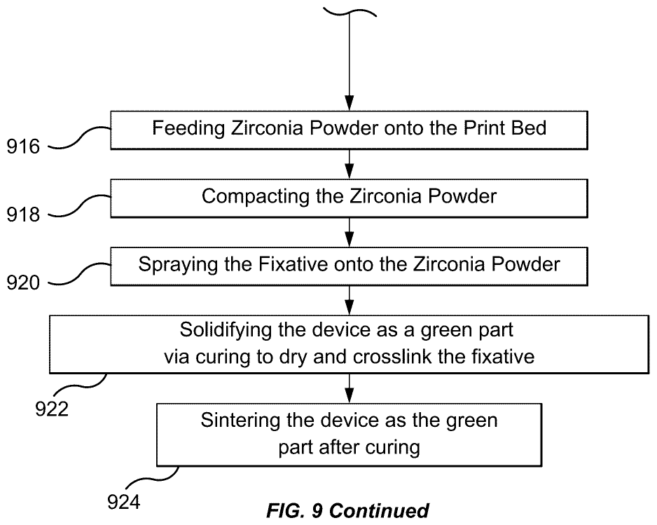

Additional details regarding method 800 are described below with respect to method 900 (FIG. 9).

FIG. 9 an illustration of a flowchart of another example method 900 for forming a quantum sensor according to an example. The method 900 may generally be implemented to form an apparatus, such as, for example, the rotating device 402 of FIG. 4, the semiconductor package 500 of FIG. 5, the electronic assembly 600 of FIG. 6, and/or the electronic assembly 700 of FIG. 7, already discussed.

Illustrated processing block 902 provides for milling or growing functionalized quantum silicon carbide powder with functionalized multivalency defects for quantum sensing.

The operation of forming a first portion of a device utilizing silicon carbide during 3D printing includes the processing blocks 904-908 described below.

Illustrated processing block 904 provides for feeding silicon carbide powder onto a print bed of a 3D printer.

Illustrated processing block 906 provides for compacting the silicon carbide powder.

Illustrated processing block 908 provides for spraying a fixative onto the silicon carbide powder to form one or more fixed silicon carbide layers.

In some implementations, the fixative comprises a slurry of liquid sodium water glass and zirconia.

In some examples, the fixative comprises a binder of one or more of a polymer binder or phenolic binder.

In some implementations, the fixative comprises a slurry of liquid sodium water glass and zirconia and a binder of one or more of a polymer binder or phenolic binder mixed together.

The operation of forming a second portion of the device utilizing functionalized quantum silicon carbide during 3D printing includes the processing blocks 910-914 described below.

Illustrated processing block 910 provides for feeding functionalized quantum silicon carbide powder onto the print bed of the 3D printer.

In some implementations, the silicon carbide powder is fed via a first powder tray and the functionalized quantum silicon carbide powder is fed via a second powder tray.

Illustrated processing block 912 provides for compacting the functionalized quantum silicon carbide powder.

Illustrated processing block 914 provides for spraying the fixative onto the functionalized quantum silicon carbide powder to form one or more functionalized quantum fixed silicon carbide layers, where the one or more functionalized quantum fixed silicon carbide layers form an embedded functionalized quantum defect in the device.

Illustrated processing block 916 provides for feeding zirconia powder onto the print bed of the 3D printer.

Illustrated processing block 918 provides for compacting the zirconia powder.

Illustrated processing block 920 provides for spraying the fixative onto the zirconia powder to form one or more fixed zirconia powder layers.

As discussed above, in other implementations, the zirconia may instead be applied via the slurry.

In still other implementations, the zirconia powder may be excluded from the slurry and zirconia powder may instead be mixed with the silicon carbide powder in the first powder tray and/or mixed with the functionalized quantum silicon carbide powder in the second powder tray.

Illustrated processing block 922 provides for solidifying the device as a green part via curing to dry and crosslink the fixative. As used herein the term “curing” involves heating the green part to a moderate elevated temperature (e.g., between 150° C. and 250° C.) to dry and crosslink the fixative.

Illustrated processing block 924 provides for sintering the device as the green part after curing. As used herein the term “sintering” involves heating the solidified green part at a high elevated temperature (e.g., between 600° C. and 1800° C., depending on the combination of fixatives used) to fuse the particles together and burn out the fixative.

In one case, the functionalized powder is optionally mixed/sprayed with a slurry during the printing process so that the functionalized powder can be sintered below 1000 degrees Celsius. An example slurry is liquid sodium water glass and zirconia. In another case, functionalized powder without a slurry is utilized and sintering occurs at a higher temperature such as 1400 degrees Celsius. In either case, a polymer or phenolic binder may also be needed to be sprayed on to the powder during printing. This slurry/polymer or phenolic binder mixture may then be burned off at a lower temperature than the sintering temperature or during sintering process itself. The functionalized powder and optional slurry/binder mix is then 3D printed using the process above to form a fully dense part with functionalized defects for quantum sensing.

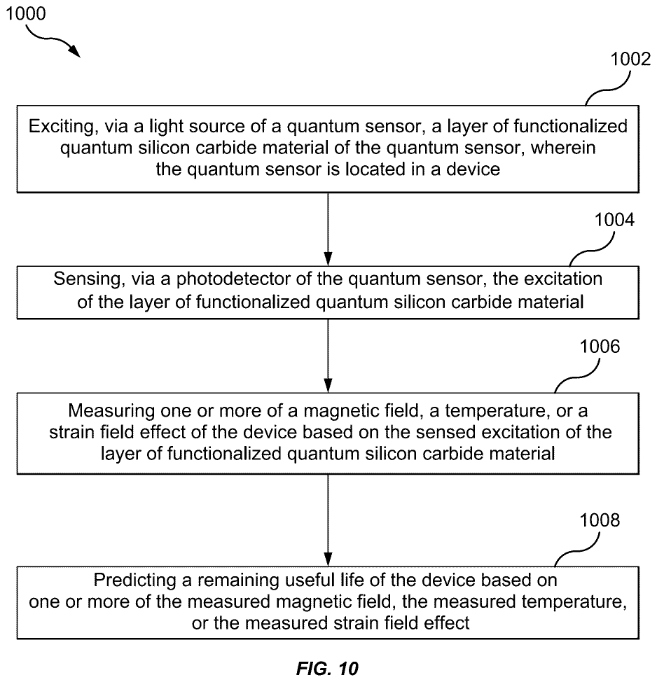

FIG. 10 is an illustration of a flowchart of an example method 1000 for quantum sensor operation according to an example. The method 1000 may generally be implemented in an apparatus, such as, for example, the rotating device 402 of FIG. 4, the semiconductor package 500 of FIG. 5, the electronic assembly 600 of FIG. 6, and/or the electronic assembly 700 of FIG. 7, already discussed.

Illustrated processing block 1002 provides for exciting, via a light source of a quantum sensor, a layer of functionalized quantum silicon carbide material of the quantum sensor, where the quantum sensor is located in a device, and where the layer of functionalized quantum silicon carbide material has color centers.

In some examples, the device comprises a plurality of 3D printed layers of silicon carbide and a plurality of 3D printed layers of functionalized quantum silicon carbide.

Illustrated processing block 1004 provides for sensing, via a photodetector of the quantum sensor, the excitation of the layer of functionalized quantum silicon carbide material.

Illustrated processing block 1006 provides for measuring one or more of a magnetic field, a temperature, or a strain field effect of the device based on the sensed excitation of the layer of functionalized quantum silicon carbide material.

Illustrated processing block 1008 provides for predicting a remaining useful life of the device based on one or more of the measured magnetic field, the measured temperature, or the measured strain field effect.

In an example, the method 1000 may be implemented in computer readable instructions (e.g., software), configurable computer readable instructions (e.g., firmware), fixed-functionality computer readable instructions (e.g., hardware), etc., or any combination thereof.

In some examples, it will be appreciated that some or all of the operations in method 1000 may be performed at least in part by cloud processing.

It will be appreciated that some or all of the operations in method 1000 are described using a “pull” architecture (e.g., polling for new information followed by a corresponding response) may instead be implemented using a “push” architecture (e.g., sending such information when there is new information to report), and vice versa.

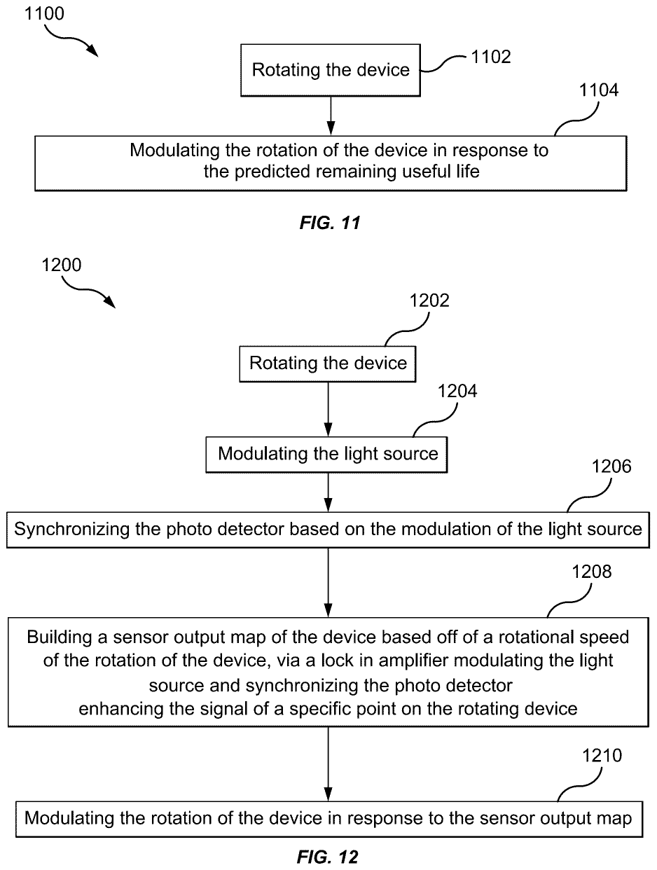

Additional details regarding method 1000 are described below with respect to methods 1100 (FIGS. 11) and/or 1200 (FIG. 12).

FIG. 11 is an illustration of a flowchart of another example method 1100 for quantum sensor operation according to an example. The method 1100 may generally be implemented in an apparatus, such as, for example, the rotating device 402 of FIG. 4, the semiconductor package 500 of FIG. 5, the electronic assembly 600 of FIG. 6, and/or the electronic assembly 700 of FIG. 7, already discussed.

Illustrated processing block 1102 provides for rotating the device.

Illustrated processing block 1104 provides for modulating the rotation of the device in response to the predicted remaining useful life.

FIG. 12 is an illustration of a flowchart of a further example method 1200 for quantum sensor operation according to an example. The method 1200 may generally be implemented in an apparatus, such as, for example, the rotating device 402 of FIG. 4, the semiconductor package 500 of FIG. 5, the electronic assembly 600 of FIG. 6, and/or the electronic assembly 700 of FIG. 7, already discussed.

Illustrated processing block 1202 provides for rotating the device.

Illustrated processing block 1204 provides for modulating the light source.

Illustrated processing block 1206 provides for synchronizing the photodetector based on the modulation of the light source.

Illustrated processing block 1208 provides for building a sensor output map of the device based off of a rotational speed of the rotation of the device, via a lock in amplifier modulating the light source and synchronizing the photodetector enhancing the signal of a specific point on the rotating device.

Illustrated processing block 1210 provides for modulating the rotation of the device in response to the sensor output map.

In operation, the light source and the photodetector may be modulated and synchronized at several thousand hertz. Then using the lock in amplifier, a sensor output map may be built based off of the rotational speed of the rotating device. For example, this might be utilized to build real-time strain maps of parts somewhat akin to laser vibrometry for turbine blade tip displacement and mode shape analysis. However, unlike laser vibrometry, this technique would readout quantum spin information for real-time information on part state of health.

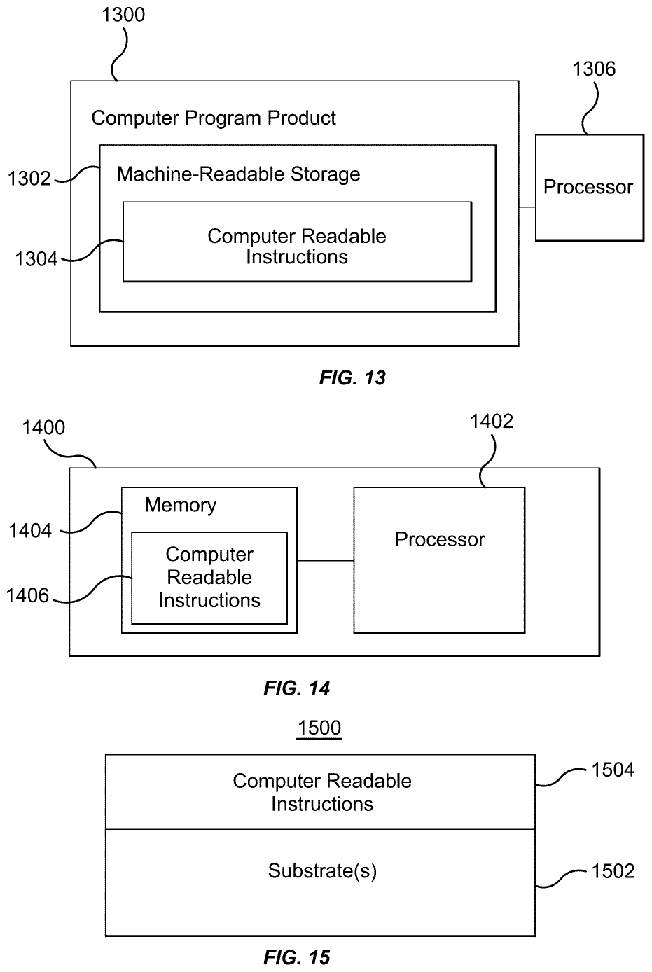

FIG. 13 illustrates a block diagram of an example computer program product 1300. In some examples, as shown in FIG. 13, computer program product 1300 includes a machine-readable storage 1302 that may also include computer readable instructions 1304. In some implementations, the machine-readable storage 1302 may be implemented as a non-transitory machine-readable storage. In some implementations the computer readable instructions 1304, which may be implemented as software, for example. In an example, the computer readable instructions 1304, when executed by a processor 1306, implement one or more aspects of the method 1100 (FIG. 11), method 1200 (FIG. 12), and/or method 1300 (FIG. 13), already discussed.

FIG. 14 shows an illustrative example of a computing apparatus 1400. In the illustrated example, the computing apparatus 1400 may include a processor 1402 and a memory 1404 communicatively coupled to the processor 1402. The memory 1404 may include computer readable instructions 1406, which may be implemented as software, for example. In an example, the computer readable instructions 1406, when executed by the processor 1402, implement one or more aspects of the method 1100 (FIG. 11), method 1200 (FIG. 12), and/or method 1300 (FIG. 13), already discussed.

In some implementations, the processor 1402 may include a general purpose controller, a special purpose controller, a storage controller, a storage manager, a memory controller, a micro-controller, a general purpose processor, a special purpose processor, a central processor unit (CPU), the like, and/or combinations thereof.

Further, implementations may include distributed processing, component/object distributed processing, parallel processing, the like, and/or combinations thereof. For example, virtual computer system processing may implement one or more of the methods or functionalities as described herein, and the processor 1402 described herein may be used to support such virtual processing.

In some examples, the memory 1404 is an example of a computer-readable storage medium. For example, memory 1404 may be any memory which is accessible to the processor 1402, including, but not limited to RAM memory, registers, and register files, the like, and/or combinations thereof. References to “computer memory” or “memory” should be interpreted as possibly being multiple memories. The memory may for instance be multiple memories within the same computer system. The memory may also be multiple memories distributed amongst multiple computer systems or computing devices.

FIG. 15 shows an illustrative semiconductor apparatus 1500 (e.g., chip and/or package). The illustrated apparatus 1500 includes one or more substrates 1502 and computer readable instructions 1504 (such as, configurable computer readable instructions (e.g., firmware) and/or fixed-functionality computer readable instructions (e.g., hardware)) coupled to the substrate(s) 1502. In an example, the computer readable instructions 1504 implement one or more aspects of the method 1100 (FIG. 11), method 1200 (FIG. 12), and/or method 1300 (FIG. 13), already discussed.

All definitions, as defined and used herein, should be understood to control over dictionary definitions, definitions in documents incorporated by reference, and/or ordinary meanings of the defined terms.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

The terms “coupled,” “attached,” or “connected” may be used herein to refer to any type of relationship, direct or indirect, between the components in question, and may apply to electrical, mechanical, fluid, optical, electromagnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples may be combined to form additional examples.

We claim:

1. A method comprising:
forming a first portion of a device utilizing silicon carbide during 3D printing by:
feeding silicon carbide powder onto a print bed of a 3D printer;
compacting the silicon carbide powder;
spraying a fixative onto the silicon carbide powder to form one or more fixed silicon carbide layers;
forming a second portion of the device utilizing functionalized quantum silicon carbide with color centers during 3D printing by:
feeding functionalized quantum silicon carbide powder onto the print bed of the 3D printer;
compacting the functionalized quantum silicon carbide powder; and
spraying the fixative onto the functionalized quantum silicon carbide powder to form one or more functionalized quantum fixed silicon carbide layers,
wherein the one or more functionalized quantum fixed silicon carbide layers form an embedded functionalized quantum defect in the device.

2. The method of claim 1, wherein the silicon carbide powder is fed via a first powder tray and the functionalized quantum silicon carbide powder is fed via a second powder tray.

3. The method of claim 1, further comprising:
feeding zirconia powder onto the print bed of the 3D printer;
compacting the zirconia powder; and
spraying the fixative onto the zirconia powder to form one or more fixed zirconia powder layers,
wherein the zirconia powder is fed via a third powder tray.

4. The method of claim 1, wherein the fixative comprises a slurry of liquid sodium water glass and a binder of one or more of a polymer binder or phenolic binder.

5. The method of claim 1, wherein the fixative comprises a slurry of liquid sodium water glass and zirconia and a binder of one or more of a polymer binder or phenolic binder mixed together.

6. The method of claim 1, the method further comprising:
solidifying the device as a green part via curing to dry and crosslink the fixative; and
sintering the device as the green part after curing.

7. The method of claim 2, wherein the first powder tray contains a mixture of silicon carbide powder and zirconia powder and the second powder tray contains a mixture of functionalized quantum silicon carbide powder and zirconia powder.

8. A method comprising:
exciting, via a light source of a quantum sensor, a layer of functionalized quantum silicon carbide material of the quantum sensor, wherein the quantum sensor is located in a device, wherein the layer of functionalized quantum silicon carbide material has color centers;
sensing, via a photodetector of the quantum sensor, the excitation of the layer of functionalized quantum silicon carbide material;
measuring one or more of a magnetic field, a temperature, or a strain field effect of the device based on the sensed excitation of the layer of functionalized quantum silicon carbide material; and
predicting a remaining useful life of the device based on one or more of the measured magnetic field, the measured temperature, or the measured strain field effect.

9. The method of claim 8, wherein the device comprises a plurality of 3D printed layers of silicon carbide and a plurality of 3D printed layers of functionalized quantum silicon carbide.

10. The method of claim 8, further comprising:
rotating the device;
modulating the light source;
synchronizing the photodetector based on the modulation of the light source; and
building a sensor output map of the device based off of a rotational speed of the rotation of the device, via a lock in amplifier modulating the light source and synchronizing the photodetector enhancing the signal of a specific point on the rotating device.

11. The method of claim 8, further comprising:
rotating the device;
modulating the light source;
synchronizing the photodetector based on the modulation of the light source;
building a sensor output map of the device based off of a rotational speed of the rotation of the device, via a lock in amplifier repeating the operations of modulating the light source and synchronizing the photodetector; and
modulating the rotation of the device in response to the sensor output map.

12. The method of claim 8, further comprising:
rotating the device; and
modulating the rotation of the device in response to the predicted remaining useful life.

13. An apparatus comprising:
a substrate comprising a plurality of 3D printed layers of silicon carbide; and
a quantum sensor located on a side of the substrate, wherein the quantum sensor comprises a plurality of 3D printed layers of functionalized quantum silicon carbide with color centers, and wherein the quantum sensor further comprises a light source and a photodetector.

14. The apparatus of claim 13, wherein the quantum sensor is configured to measure one or more of a magnetic field, a temperature, or a strain field effect.

15. The apparatus of claim 13, wherein the apparatus comprises a rotatable device and wherein the plurality of 3D printed layers of functionalized quantum silicon carbide are located at least partially on an outer diameter of the rotatable device.

16. The apparatus of claim 15, further comprising a lock in amplifier to repeat operations of modulating the light source and synchronizing the photodetector to build a sensor output map of the apparatus based off of a rotational speed of the rotation of the apparatus.

17. The apparatus of claim 13, wherein the apparatus comprises a cold plate coupled to an integrated circuit.

18. The apparatus of claim 13, wherein the apparatus comprises a heat sink coupled to an integrated circuit.

19. The apparatus of claim 13, wherein the apparatus comprises a ceramic substrate coupled to an integrated circuit in a semiconductor package.

20. The apparatus of claim 13, wherein the apparatus is incorporated into a vehicle.
